(19) United States
(12) Patent Application Publication
(10) Pub. No.: US 2006/0149754 A1
(43) Pub. Date: Jul. 6, 2006

(54) Integrated structural and process configuration

(76) Inventors: Alexander Dreiling, Paddington (AU); Michael Rosemann, Windsor (AU); Karsten A. Schulz, Middle Park (AU); Wasim Sadiq, Westlake (AU); Florian Gottschalk, Hemmingen (DE)

Correspondence Address: PERKINS COIE LLP, 101 JEFFERSON DR, PO BOX 2168, MENLO PARK, CA, 94025, US

(21) Appl. No.: 11/027,716

(22) Filed: Dec. 30, 2004

(51) Int. Cl. G06F 7/00

(52) U.S. Cl. 707/100

(57) ABSTRACT

A computer-implemented method for integrating structural and process configuration includes configuring a business structure and configuring business processes of the business structure. The configured business structure and the configured business processes are then linked into a linked business process structure. Finally, a plurality of independent processes are derived for each subunit of the business structure based on the linked business process structure.

### DESCRIPTION OF THE RELATED ART

Organizations often have many layers corresponding to subunits or divisions. The subunits, in turn, are frequently further subdivided based on a number of factors such as business function or geographic location. Due to this layering, each subunit (or subunit of a subunit) will often develop their own unique processes that fit their particular situation. In other words, a process that works well for one subunit will not necessarily be optimal for another subunit.

When implementing enterprise resource planning (“ERP”) software (also sometimes referred to as enterprise systems) across a complex organization that has various subunits, difficulties are often encountered when trying to accommodate the varying needs of the subunits. Setting up one process in the ERP software for a particular business function will simply not suffice. As a result, an ERP software implementation very often will become extraordinarily complex. This added complexity often translates into delays and the cost of the ERP software implementation goes up accordingly.

Additionally, configuration of contemporary enterprise systems is mainly driven by the target structure of the organization that undertakes the enterprise system implementation project. Apart from the organization's structure, the targeted processes that need to be supported by the enterprise system need to be configured as well. However, there is a lack of explicit support of process configuration. Such support can only be considered explicit if process models are involved in the configuration processes that are configured according to the requirements of the organization. In addition, the process models need to explicitly highlight the points, possibilities and consequences of configuration decisions.

Furthermore, structural configuration focuses on modeling the organization's structure in terms of managerial units, units that need to file separate balance sheets, hierarchical organizational structures, etc. The support for explicit process configuration (process configuration is typically achieved by switching functionality on and off and by that, the process will be implicitly changed. I.e., there is no visualization or explicit support in terms of process models) is necessary, but even more this support needs to be integrated into the existing configuration process.

In view of the foregoing, it may be useful to provide methods and systems that facilitate the implementation of ERP software such that the needs of the individual subunits can be met without causing delays.

### SUMMARY OF EMBODIMENTS OF THE INVENTION

The present invention is described and illustrated in conjunction with systems, tools and methods of varying scope which are meant to be exemplary and illustrative, not limiting in scope.

A computer-implemented method for integrating structural and process configuration, in accordance with an exemplary embodiment, includes configuring a business structure and configuring business processes of the business structure. The configured business structure and the configured business processes are then merged into a linked business process structure. Finally, a plurality of independent processes are derived for each subunit of the business structure based on the linked business process structure.

A computer-implemented method for integrating structural and process configuration, in accordance with another exemplary embodiment, includes configuring a business structure and business processes of this business structure. The configured business structure and the configured business processes are then linked into a business process structure wherein linking the configured business structure and the configured business processes into the linked business process structure includes identifying the subunits of the business structure, identifying the business processes of the business structure and linking the business processes to each subunit of the business structure. A plurality of independent processes are then derived for each subunit of the business structure based on the linked business process structure wherein deriving the plurality of independent processes for each subunit of the business structure based on the linked business process structure includes searching for a similar function in a related organization for each function of the linked business process structure, copying the similar function to each subunit of the business structure if there is not an organizational break between each subunit of the business structure and the related organization and modifying each function of the linked business process structure if there is an organizational break between each subunit of the business structure and the related organization.

In addition to the aspects and embodiments of the present invention described in this summary, further aspects and embodiments of the invention will become apparent by reference to the drawings and by reading the detailed description that follows.

### BRIEF DESCRIPTION OF THE DRAWINGS

FIG. 1 is block diagram illustrating an organizational communications network;

FIG. 2 is a chart illustrating an organization with various subunits;

FIG. 3 is a flowchart illustrating a method to integrate structure process, in accordance with an exemplary embodiment;

FIG. 4 is a flowchart further illustrating the integrate structure process of FIG. 3; in accordance with an exemplary embodiment;

FIG. 5 is a flowchart further illustrating the process of linking business process and structural configuration of FIG. 4, in accordance with an exemplary embodiment;

FIG. 6 is a flowchart further illustrating the process of deriving independent processes for each subunit of FIG. 4, in accordance with an exemplary embodiment;

FIG. 7 is a block diagram illustrating an invoice verification process, in accordance with an exemplary embodiment;

FIG. 8 is a block diagram illustrating an invoice verification process with functions allocated to various offices, in accordance with an exemplary embodiment;

FIG. 9 is a block diagram illustrating a blocked invoice segment of an invoice verification process, in accordance with an exemplary embodiment;

FIG. 10 is a block diagram illustrating how blocked invoices are processed, in accordance with an exemplary embodiment;

FIG. 11 is a block diagram illustrating an invoice verification process in a specific branch office, in accordance with an exemplary embodiment; and

FIG. 12 is a block diagram illustrating an invoice process flow between restricted organizational units, in accordance with an exemplary embodiment.

### DETAILED DESCRIPTION

An aspect of the present invention contemplates a variety of methods and systems for efficiently implementing ERP software in an organization with multiple subunits. By independently configuring business structures and business processes and then linking them together, unique business processes for each subunit can be efficiently produced and deployed.

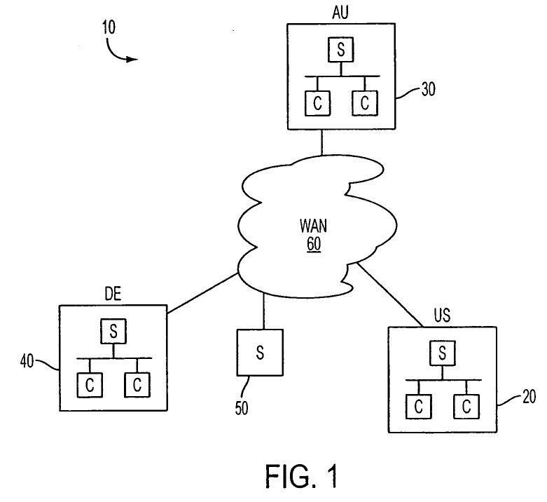

FIG. 1 is block diagram illustrating an organizational communications network 10. Included in network 10 are various geographical subunits such as U.S. subunit 20, Australia subunit 30 and Germany subunit 40. Also included is a server 50 and a wide area network (“WAN”). Each of the subunits (20, 30 and 40) and the server 50 can all communicate with each other via WAN 60. Server 50 typically houses organization-wide processes such as email while the subunits (20, 30 and 40) each house their own unique processes. Also included in each subunit (20, 30 and 40) is a sub-network of servers and clients.

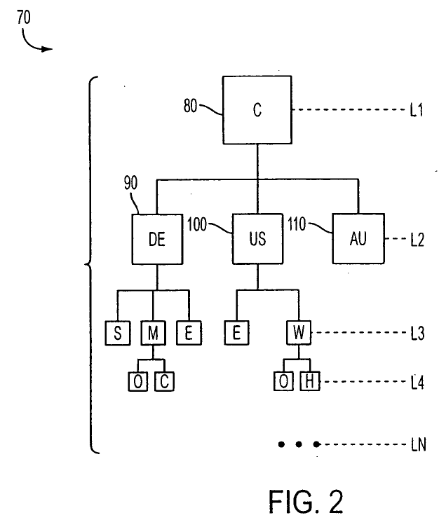

FIG. 2 is a chart 70 illustrating an organization with various subunits. At the top layer (L1) of chart 70 resides the company headquarters. In the next layer L2, the organization is subdivided into three geographical subunits as defined by Germany subunit 90, U.S. subunit 100 and Australia subunit 110. Each of subunits 90, 100 and 110 can then perhaps be further subdivided at layers L3, L4 through LN. Layers L3 through LN could perhaps be a business unit or a division or some other business entity.

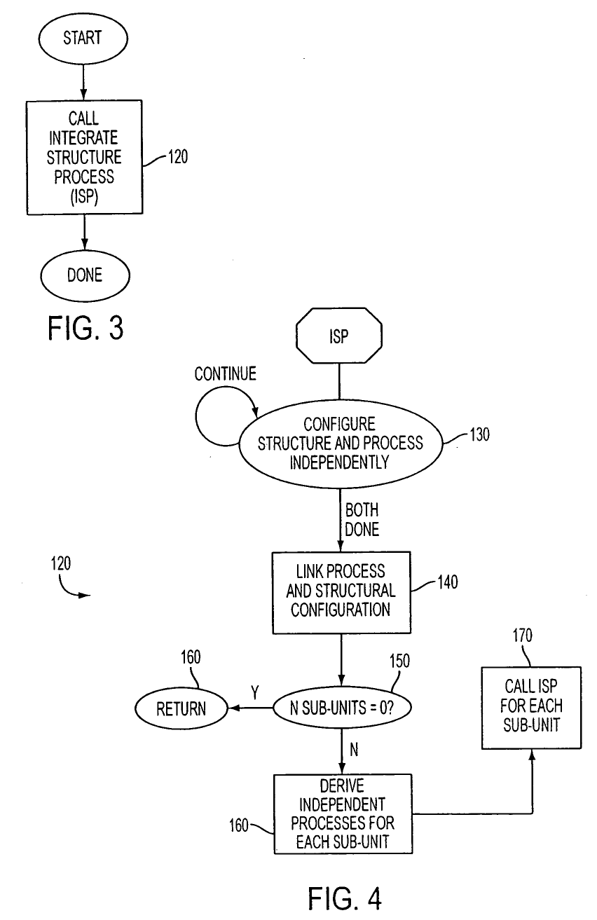

FIG. 3 is a flowchart illustrating a method 120 to integrate structure process (“ISP”), in accordance with an exemplary embodiment. After a start operation, the integrate structure process is called at an operation 120. FIG. 4 is a flowchart further illustrating the integrate structure process 120 of FIG. 3; in accordance with an exemplary embodiment. After calling ISP, a business structure and business processes are both configured independently of each other at an operation 130. Operation 130 continues until the entire business structure and all of the business processes have been configured. Once operation 130 is completed, the configured business structure and the configured business processes are linked together at an operation 140. If there are no subunits, then the process 120 is completed via operations 150 and 160. If the number of subunits is not equal to zero, then independent processes are derived for each subunit based on the linked business process structure, at an operation 160. If there are further subunits to configure, then ISP can additionally be called for other subunits at operation 170.

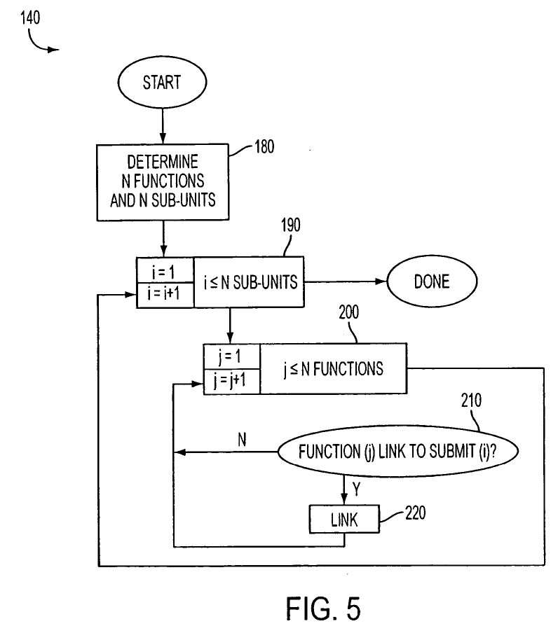

FIG. 5 is a flowchart further illustrating the process 140 of linking business process and business structural configuration of FIG. 4, in accordance with an exemplary embodiment. After a start operation, the number of business functions and the number of subunits is determined at an operation. A counter 190 is then initialized to 1 and looped through the number of subunits. For each loop of counter 190, a second counter 200 is executed for the number of functions. At an operation 210, it is decided whether to link function(j) to subunit(i). If yes, it is linked at operation and control is passed back to counter 200 for the next loop. Once counter 190 is done looping, process 140 is then completed.

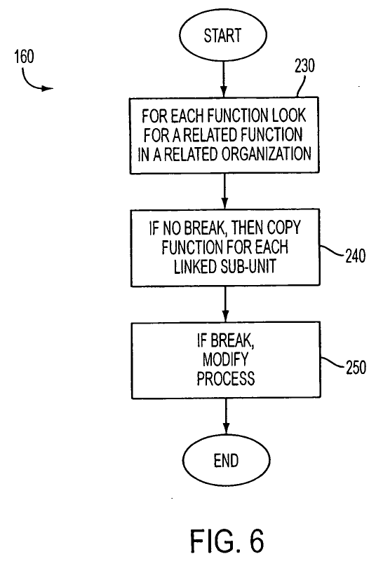

FIG. 6 is a flowchart further illustrating the process 160 of deriving independent processes for each subunit of FIG. 4, in accordance with an exemplary embodiment. After a start operation, for each business function a related function is searched for in a related organization, at an operation 230. If a related function is found and there is no organizational break between the organization of the business function and related organization of the related function, then the related function is copied to the business function, at an operation 240. If there is a break, then the business function needs to be modified at an operation 250.

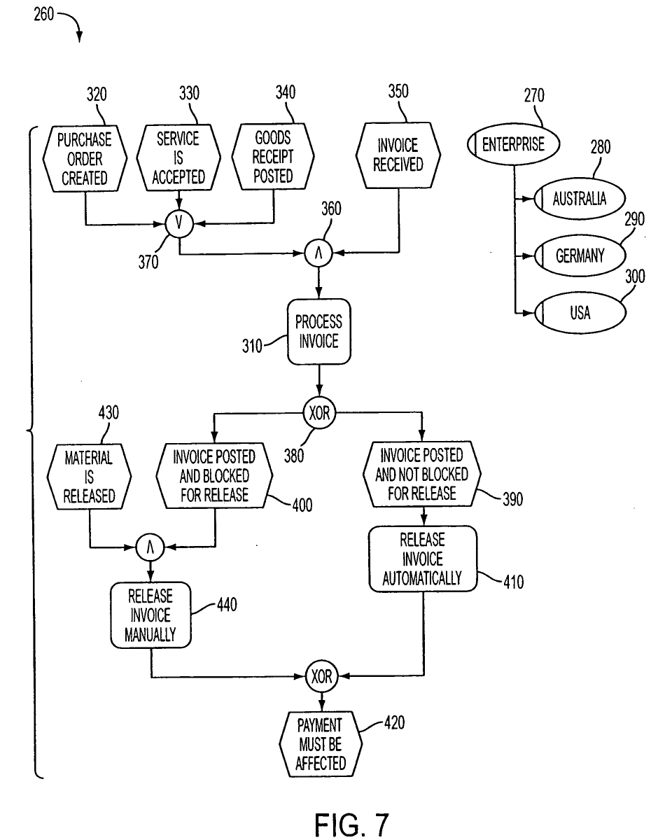

To further illustrate an exemplary embodiment, an invoice verification example will now be presented. FIG. 7 is a block diagram 260 illustrating an invoice verification process, in accordance with an exemplary embodiment. Symbols such as symbol 360 is an AND function, symbols such as symbol 370 is an OR function and symbols such as symbol 380 is an exclusive OR function. Diagram 260 represents the configured structural and process configuration for an organization 270 that has subunits in Australia 280, Germany 290 and the U.S.A. 300. In this particular diagram 270, all three subunits (280, 290 and 300) perform invoice verification in the same manner. In order to process an invoice at operation 310, a purchase order can be created at operation 320, or the service must be accepted at operation 330, or a goods receipt must be posted at operation 340 and the invoice must be received at operation 350. After the invoice is processed at operation 310, it can either be posted and not blocked for release at operation 390 or posted and blocked for release at operation 400. If the invoice is not blocked, then it is released automatically and payment is sent, via operations 410 and 420. If the invoice was blocked at operation 400, then the involved material must first be released at operation 430 and the invoice is released manually at operation 440. Finally, payment can be affected at operation 420.

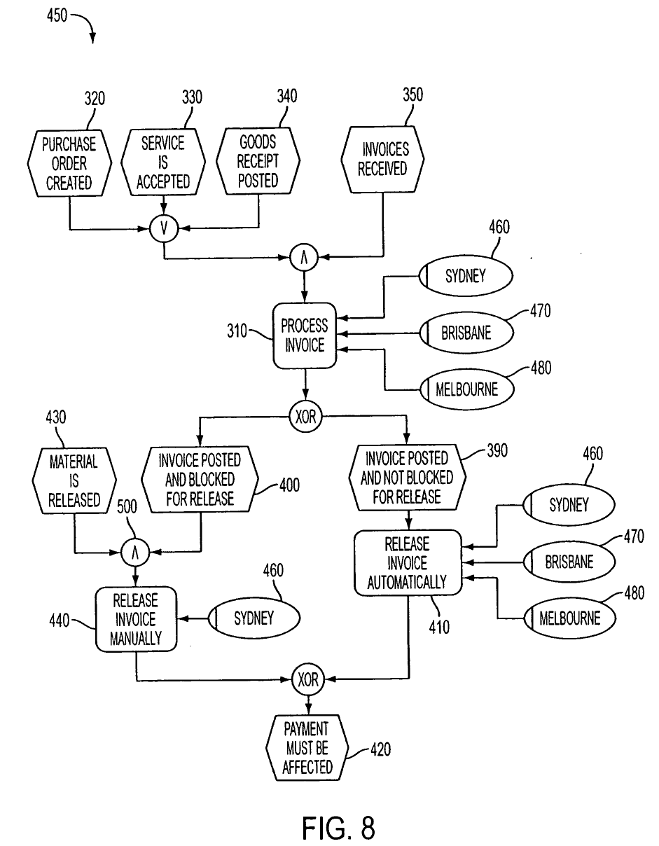

Now that the invoice verification process has been configured for organization/enterprise 270 as a whole, it is desired to perform further customization for the Australia subunit 280 that has three offices. FIG. 8 is a block diagram 450 illustrating an invoice verification process with functions allocated to various offices, in accordance with an exemplary embodiment. Block diagram 450 further includes the Australia subunit's 280 regional offices—Sydney 460, Brisbane 470 and Melbourne 480. In this particular further customization, it is desired that if any invoices are blocked at operation 400, then only the Sydney office 460 can release the invoices. To achieve this, only Sydney is given access to operation 440.

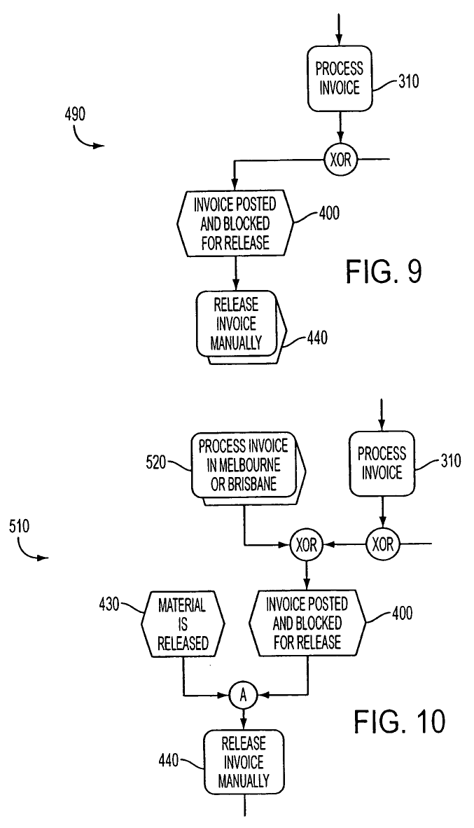

However, what if the invoice was blocked by processing in Brisbane 470 or Melbourne 480? This is addressed with consideration to FIG. 9 which is a partial block diagram 490 illustrating a blocked invoice segment of an invoice verification process, in accordance with an exemplary embodiment. In partial block diagram 490, the Brisbane 470 and Melbourne. 480 offices get new process interfaces to the Sydney 460 office via the removal of OR symbol 500 of Fig, 8.

To further refine the situation where an invoice gets blocked by the Melbourne. 470 office and the Brisbane 480 office, the Sydney 460 office should also receive a new possible start with a process interface from the. Melbourne 470 and Brisbane 480 offices such as depicted in FIG. 10 which is a partial block diagram illustrating how blocked invoices are processed, in accordance with an exemplary embodiment. With the addition of operation 520, a blocked invoice in Melbourne 470 or Brisbane 480 can be sent directly to Sydney to be released.

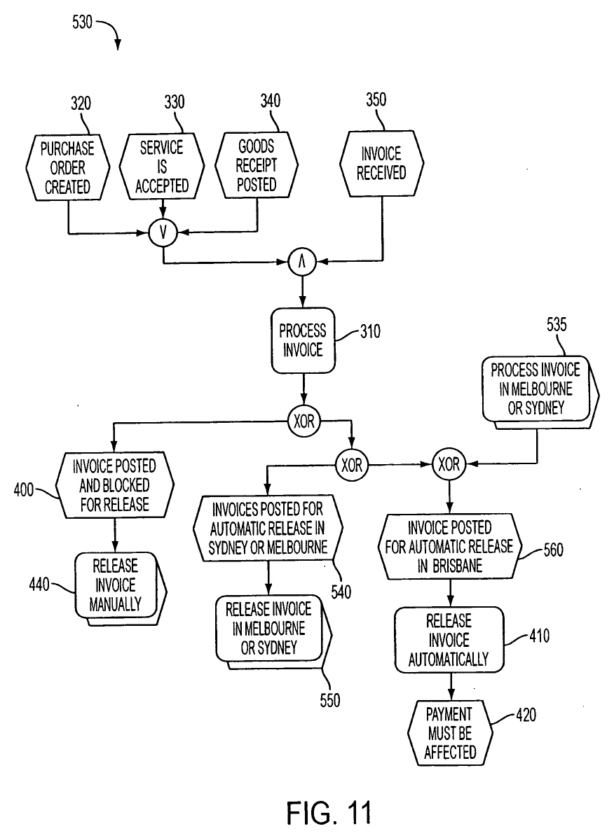

Referring back to FIG. 8, the similar problem of a blocked invoice at an office besides Sydney 460 can occur in regards to the automatic releasing of invoices. For example, an invoice released in Brisbane 470 can be released in Brisbane 470 as well as in Melbourne 480 or Sydney 460. As a result, process interfaces must be placed in between these functions and can be seen in FIG. 11 which is a block diagram 530 illustrating an invoice verification process in a specific branch office (Brisbane 470), in accordance with an exemplary embodiment. An invoice can be processed in Melbourne 480 or Sydney 460 at operation 535. Subsequently, it can be posted for automatic release in Melbourne 480 or Sydney 460 at operation 540 and then released at operation 550. Conversely, the invoice could perhaps be posted for automatic release in only Brisbane 470, via operation 560. If so, the invoice is released automatically and payment is affected at operations 410 and 420.

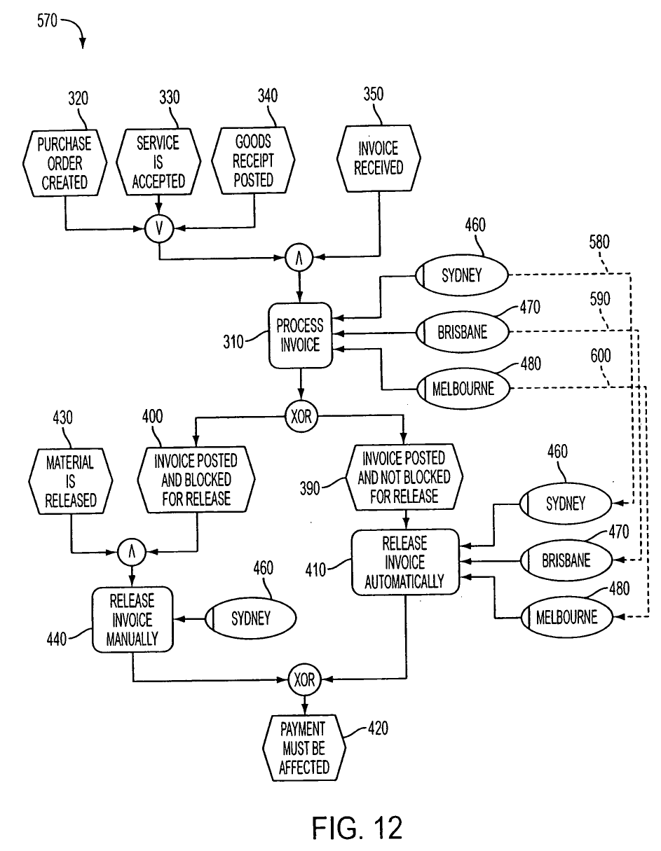

However, it is possible that every invoice processed in Brisbane should automatically be released in Brisbane 470 and nowhere else. If this is the case, the process flow between the organizational units (460, 470 and 480) needs to specified in the overall process flow, such as the one depicted in Fig. 12 which is a block diagram 570 illustrating an invoice process flow between restricted organizational units, in accordance with an exemplary embodiment. The process flow between the organizational units (460, 470 and 480) are indicated by dashed arrows 580, 590 and 600. The dashed arrows (580, 590 and 600) clarifies that every instance handled by one organizational unit (460, 470 and 480) in the first function needs to be handled by one of the specified organizational units (460,470 and 480) in the second function (assuming that the overall process flow reaches the second function). Furthermore, the dashed arrows (580, 590 and 600) are only used if they are needed for configuration. This is only the case if an instance handled by one organizational unit in one function is not allowed to be handled by an organizational unit allocated to another function. If a tool is used for integrated structural and process configuration, the additional process flow arrows should only be displayed after the selection of an allocated organizational unit.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A computer-implemented method for integrating structural and process configuration comprising:
configuring a business structure;
configuring business processes of the business structure;
linking the configured business structure to the configured business processes into a linked business process structure; and
deriving a plurality of independent processes for each subunit of the business structure based on the linked business process structure.

2. The computer-implemented method as recited in claim 1 wherein linking the configured business structure and the configured business processes into the linked business process structure comprises:
identifying the subunits of the business structure;
identifying the business processes of the business structure; and
linking the business processes to each subunit of the business structure.

3. The computer-implemented method as recited in claim 1 wherein deriving the plurality of independent processes for each subunit of the business structure based on the linked business process structure comprises:
searching for a similar function in a related organization for each function of the linked business process structure;
copying the similar function to each subunit of the business structure if there is not an organizational break between each subunit of the business structure and the related organization; and
modifying each function of the linked business process structure if there is an organizational break between each subunit of the business structure and the related organization.

4. The computer-implemented method as recited in claim 1 wherein the subunits of the business structure have additional subunits beneath the subunits of the business structure and the method further comprises:.
configuring a subunit business structure;.
configuring subunit business processes of the business structure;
linking the configured subunit business structure to the configured subunit business processes into a linked subunit business process structure; and
deriving a plurality of independent subunit processes for each additional subunit beneath the subunits of the business structure based on the linked subunit business process structure.

5. A computer-implemented method for integrating structural and process configuration comprising:
configuring a business structure;
configuring business processes of the business structure;
linking the configured business structure to the configured business processes into a linked business process structure wherein linking the configured business structure and the configured business processes into the linked business process structure includes:
a) identifying the subunits of the business structure;
b) identifying the business processes of the business structure; and
c) linking the business processes to each subunit of the business structure; and
deriving a plurality of independent processes for each subunit of the business structure based on the linked business process structure wherein deriving the plurality of independent processes for each subunit of the business structure based on the linked business process structure includes:
a) searching for a similar function in a related organization for each function of the linked business process structure;
b) copying the similar function to each subunit of the business structure if there is not an organizational break between each subunit of the business structure and the related organization; and
c) modifying each function of the linked business process structure if there is an organizational break between each subunit of the business structure and the related organization.
